(19) United States
(12) Patent Application Publication
(10) Pub. No.: US 2012/0032374 A1
(43) Pub. Date: Feb. 9, 2012

(54) MOULD FOR PRODUCING BONE CEMENT PELLETS

(75) Inventors: John Stephen BRATT, Newcastle-under-Lyme (GB); John Warren COLCLOUGH, Stoke-on-Trent (GB); Gerhard Emil MAALE, Dallas, TX (US); David Russell WATERS, Audlem (GB)

(73) Assignee: Biocomposites Limited, Keele (GB)

(21) Appl. No.: 13/180,477

(22) Filed: Jul. 11, 2011

(30) Foreign Application Priority Data
Jul. 12, 2010 (GB) 1011614.3

(51) Int. Cl. B29C 45/00; B29C 45/26

(52) U.S. Cl. 264/328.2; 425/588

(57) ABSTRACT

A mould for producing bone cement pellets, the mould comprising a plurality of complementarily shaped mould segments which fit together to make a composite mould having a plurality of individual mould cavities and one or more injection ports for feeding, in use, hardenable bone cement to said mould segments and said plurality of individual mould cavities.

The present invention provides an apparatus and method for producing bone cement pellets i.e. hardened pellets of a bioabsorbable bone substitute material suitable for the treatment of bone disorders and filling of bony voids or defects of the skeletal system. In particular, although not exclusively, the present invention provides a simple means to produce moulded, hardened pellets (e.g. spheroidal pellets) of a calcium-based bone cement having a range of sizes for the treatment of bone disorders and filling bone defects.

The use of calcium salt based bone substitute materials is common practice in orthopaedic surgical procedures for the filling of bony voids or gaps of the skeletal system caused by either trauma or surgery. These materials when implanted are intended to resorb and be replaced by new bone as they do so. They can consist of a range of different calcium based salts incorporating sulphate and/or phosphate based anions. They may be provided in a range of physical forms including granules and pellets.

There are a number of calcium based bone substitute materials which may be used as bone void fillers. These are typically supplied in the form of a powder which when mixed with an aqueous liquid component form a hardenable cohesive mass that cures and finally sets to form a calcium based bone cement.

Calcium sulphate hemi-hydrate is one such calcium based bone substitute material. When the calcium sulphate hemi-hydrate powder is blended with an appropriate quantity of water or salt solution, the mixture hydrates to form a cohesive mass and sets with a mildly exothermic reaction to give calcium sulphate di-hydrate (i.e. the bone cement) according to the following reaction:

CaSO₄½H₂O (Plaster of Paris)+1½H₂O═CaSO₄2H₂O (gypsum)

The calcium sulphate hemi-hydrate may be used alone or it may be used in combination with a calcium phosphate based bone substitute material.

Calcium phosphate cement (CPC) is a synthetic bone graft material that was invented in 1986 by L. C. Chow and W. E. Brown, scientists at the American Dental Association. The cement is formed from a calcium phosphate based bone substitute material comprising a white powder consisting of equimolar amounts of ground Ca₄(PO₄)₂O (tetracalcium phosphate, TTCP) and CaHPO₄ (dicalcium phosphate anhydrous, DCPA). The powder when mixed with water forms a workable paste which can be shaped during surgery to fit the contours of a wound. The paste hardens (i.e. fully sets) within 20 min to form the calcium phosphate cement, thereby allowing rapid closure of the wound. The hardening reaction, which forms nanocrystalline hydroxyapatite (HA) as the product, is isothermic and occurs at physiologic pH so tissue damage does not occur during the setting reaction.

There are now available a number of different formulations of calcium phosphate cements (CPCs). These may contain a range of calcium based salts including monocalcium phosphate, dicalcium phosphate, tetracalcium phosphate, octacalcium phosphate and calcium carbonate and combinations thereof. The calcium based salts are mixed together with an aqueous mixing liquid which may also contain soluble phosphates such as sodium phosphate or phosphoric acid.

Depending upon the surgical procedure being undertaken and the surgeon's preference, it may be required to use the cement in the form of pellets or granules. A granular bed of bone graft material contains inter-granule porosity, and this is often considered to be a pre-requisite for bony in-growth. A granular or pelletized form of bone graft material also enables the material to be mixed with morselised autograft, an often conducted practice in many surgical procedures. It is important to ensure the cast or moulded pellets do not contain significant quantities of voids and have a uniform pellet shape otherwise this may impact on their packing density, their strength and their resorption profile.

For a bone cement to be available in the form of pellets, some form of pellet mould is required and this is often provided by the supplier of the bone substitute material for forming the bone cement. This generally takes the form of a rectangular, flat, two dimensional mat, made from a flexible rubber or polymeric material and containing a series of cylindrical or hemispherical cavities. The bone cement is prepared in the normal manner by mixing all of the powder with all of the liquid. The resulting intermediate paste (i.e. hardenable bone cement) is then pressed into the pellet cavities, for example by using a spatula, where it is allowed to harden and set. Once fully hardened the mould mat can be flexed to extract all pellets from the mould. Pasting the cement into the cavities of the mould mat is a messy and time consuming operation; it typically also results in a waste of expensive bone substitute material. Additionally, it is difficult to ensure that the hardenable bone cement does not entrap air while filling the mould and hence it is difficult to provide pellets which do not contain significant quantities of voids and pellets having a uniform shape.

The present invention seeks to overcome one or more of the aforementioned technical problems for forming bone cement pellets.

Thus in accordance with a first aspect, the present invention provides a mould for producing bone cement pellets, the mould comprising a plurality of complementarily shaped mould segments which fit together to make a composite mould having a plurality of individual mould cavities and one or more injection ports for feeding, in use, hardenable bone cement to said mould segments and said plurality of individual mould cavities.

Suitably, the plurality of individual mould cavities are contained within the assembled mould.

Advantageously, the mould of the first aspect of the present invention permits the formation of bone cement pellets in a straightforward and simple manner whilst minimizing wastage of expensive bone substitute material. Typically, the bone substitute material is admixed with an aqueous solution in the usual manner to produce a hardenable bone cement in the form of a paste which is then injected (e.g. manually using a syringe) into the assembled mould where it hardens (i.e. cures and fully sets) to form a plurality of bone cement pellets; the operation negating the need to paste the hardenable bone cement directly into a plurality of mould cavities of a mould mat. After the hardenable bone cement has set to form the bone cement pellets, the mould is opened and the pellets removed. Suitably, the bone cement pellets are typically of a uniform shape and do not contain significant quantities of voids due to air entrapment, thereby promoting, in use, dense packing of bony voids and bony defects and consistent bioabsorption of the bone cement pellets.

Preferably, each mould segment comprises a mould member with one or more injection channels running along its length and a plurality of individual mould cavities distributed around said one or more injection channels and directly linked to the one or more injection channels by one or more feeder lines to receive, in use, the hardenable bone cement. Conveniently, such an arrangement enables the length of the injection channel to be minimized and the number of individual mould cavities maximized in each mould segment, thereby maximizing the number of bone cement pellets formed from a predetermined quantity of bone substitute material. Suitably, said plurality of mould segments, when assembled together, define between them one or more injection pathways in fluid communication with said one or more injection ports for the introduction, in use, of the hardenable bone cement material.

Suitably, the plurality of individual mould cavities may be of identical or differing size. In a preferred aspect the plurality of individual mould cavities include cavities of two or more differing sizes. Advantageously, such an arrangement permits the formation of different sized bone cement pellets from a single moulding operation.

Preferably, a mould segment, more preferably each mould segment, comprises one or more supplementary mould cavities which are linked to said injection channel via one or more of said directly linked mould cavities. Preferably, the one or more supplementary mould cavities are serially linked to the one or more directly linked mould cavities. Preferably, said one or more supplementary mould cavities comprises a mould cavity of a different size to its associated, directly linked, cavity. Advantageously, such an arrangement not only permits the formation of different sized bone cement pellets from a single moulding operation, but also it has been found that this arrangement may provide a particularly good result in terms of pellet shape and uniformity of consistency. Suitably, pellets having a range of sizes have been found to fill the dead space of bony voids more effectively than pellets of a single size alone.

Suitably, a mould segment, preferably each mould segment may include further mould cavities serially linked to the supplementary cavities.

In accordance with a preferred embodiment, each mould member includes a single injection channel running along its length. Suitably, the plurality of mould segments, when assembled together, define between them a single injection pathway, preferably a single central injection pathway, for the introduction, in use, of hardenable bone cement. Suitably, the single injection pathway is in fluid communication with the one or more injection ports for the introduction, in use, of the hardenable bone cement material. Preferably, the assembled mould includes a single injection port which is in fluid communication with the single injection pathway.

In accordance with an alternative embodiment, each mould member includes a first injection channel and a second separate injection channel running along its length and said plurality of individual mould cavities comprises a plurality of first individual mould cavities and a plurality of second individual mould cavities, wherein the plurality of first individual mould cavities are distributed around the first injection channel and directly linked to it by one or more feeder lines and the plurality of second individual mould cavities are distributed around the second separate injection channel and directly linked to it by one or more feeder lines. Preferably, the plurality of first individual mould cavities comprises a mould cavity of a different size than the plurality of said second individual mould cavities. Suitably, the plurality of mould segments, when assembled together, define between them a first injection pathway and a second separate injection pathway, preferably a first central injection pathway and a second separate central injection pathway, for the introduction, in use, of hardenable bone cement. Suitably, the first and second injection pathways are in fluid communication with the one or more injection ports for the introduction, in use, of the hardenable bone cement material. Preferably, the first injection pathway is in fluid communication with a first injection port and the second separate injection pathway is in fluid communication with a second separate injection port. Advantageously, such an arrangement permits the selective formation of bone cement pellets having a different size using a single mould.

Preferably, each mould segment is arranged to co-operate with a neighbouring mould segment to either side. Preferably, each mould cavity comprises a half cavity for a finished bone cement pellet, such that each pair of co-operating mould segments bring together adjoining pairs of half mould cavities for forming the complete bone cement pellet.

Preferably, each mould segment includes alignment features for automatically aiding the alignment of adjoining mould segments and adjoining mould cavities, when present, relative to each other. Suitably, such alignment features may comprise male and female co-operative parts (i.e. the edges of each mould segment may comprise co-operative castellated segments). Preferably, said alignment features serve to interlock the mould segments together.

Preferably, the mould includes one or more air bleed channels to permit escape of air from the mould during injection of the hardenable bone cement. Preferably, each of said individual mould cavities and/or supplementary mould cavities, if present, may include an air bleed outlet to at least one air bleed channel. Such an arrangement not only allows escape of air from the assembled mould during filling with the hardenable bone cement, but also prevents entrapment of air during hardening of the hardenable bone cement thereby providing pellets of uniform consistency and without defects and voids. Suitably, the one or more air bleed channels and air bleed outlets, when present, are dimensioned to permit escape of air but not expulsion of the hardenable bone cement from the mould. This may be achieved by ensuring the dimension (i.e. diameter) of the air bleed channel is small compared with the dimension of the powder material of the bone substitute material.

Preferably, the assembled mould is an elongate, generally prismatic in shape, mould that is tapered end to end where the taper has an angle of 0° to about 10° and the injection port for injecting the hardenable bone cement is provided at the end of the mould having the greater cross sectional area. Advantageously, such an arrangement pushes the mould segments together (when located in the frame as described hereinafter) during filling of the mould.

In accordance with a preferred embodiment, the assembled mould includes a pluggable inspection hole, preferably at the end of the assembled mould opposite the injection port. The pluggable inspection hole allows the user to assess the cured status of the hardenable bone cement prior to opening the mould, thereby preventing premature opening of the mould. Suitably, the pluggable inspection hole when opened reveals one or more bone cement pellets.

Preferably, each of said mould segments are constructed of a flexible, for example polymeric or rubber, material to facilitate removal of the bone cement pellets from the mould. Conveniently, the assembled mould is dimensioned so that it may be hand held.

Preferably, the assembled mould, in use, includes a rigid frame for surrounding the mould and to prevent the mould segments of the assembled mould being forced apart during filling with the hardenable bone cement. Preferably, the frame is elongate with a length between about 40 mm to about 170 mm and generally prismatic in shape having inner dimensions which are arranged to conform closely to the outer dimensions of the assembled mould, which will have a length between about 40 mm to about 170 mm. Suitably, when the assembled mould is an elongate mould that is tapered end to end, the frame is tapered end to end, where the taper has an angle between 0° and about 10° and dimensioned similarly to permit a snug fit. Conveniently, having the injection port for injecting the hardenable bone cement at the end of the assembled mould having the greater cross sectional area ensures that the mould segments are forced into the frame during filling of the mould, rather than out of the frame.

The bone cement pellet geometry may be spherical or hemispherical, or alternatively spheroidal, ellipsoidal or cylindrical, or a combination of these geometries. Suitably, the plurality of individual mould cavities and the one or more supplementary mould cavities, when present, may be shaped accordingly to produce such bone cement pellet geometries.

Preferably, the bone cement pellets produced using the assembled mould of the first aspect of the present invention have a minimum largest dimension (i.e. minimum diameter for a spherical pellet or minimum length for a cylindrical pellet) of greater than 0.5 mm, more preferably greater than 1.0 mm, most preferably greater than 1.5 mm. Preferably, the bone cement pellets have a maximum largest dimension of less than 9 mm, more preferably less than 8 mm, most preferably less than 7 mm. Suitably, the plurality of individual mould cavities and the one or more supplementary mould cavities, when present, are dimensioned accordingly.

In accordance with a second aspect, the present invention provides a frame as defined in accordance with the first aspect of the invention for surrounding a mould of the first aspect of the invention.

In accordance with a third aspect, the present invention provides a kit of parts for producing bone cement pellets, said kit comprising: an assemblable mould formed from a plurality of complementarily shaped mould segments, which, when assembled together, form a composite mould having a plurality of individual mould cavities and one or more injection ports for feeding, in use, hardenable bone cement to said mould segments and said plurality of individual mould cavities; and, a frame for co-operation with the assembled mould during an injection and hardening (i.e. fully setting or curing) process of the hardenable bone cement.

Preferably, the mould comprises a mould in accordance with the first aspect of the invention and the frame comprises a frame in accordance with the second aspect of the invention. Suitably, the mould may be provided in an assembled form.

Preferably, the kit of parts includes a bone substitute material for forming the hardenable bone cement. Preferably, the kit of parts further includes a syringe for injecting hardenable bone cement into the assembled mould.

In accordance with a fourth aspect, the present invention provides a method of producing bone cement pellets, the method comprising: injecting hardenable bone cement into an assembled mould of the first aspect of the invention; allowing said hardenable bone cement to harden fully (i.e. fully set) in the mould; and, disassembling the mould to access the produced bone pellets. Preferably, the method further comprises the step of inserting the mould into a relatively rigid frame prior to injecting the hardenable bone cement material.

Preferably, the frame comprises a frame in accordance with the second aspect of the invention.

In accordance with a fifth aspect, the present invention provides a method of filling a bony void or bony defect in the skeletal system, the method comprising forming a plurality of bone cement pellets in accordance with the fourth aspect of the invention and filling a bony void or bony defect with the pellets.

In this specification, the following words and expressions, if and when used, have the meanings ascribed below:
“bone cement” means a hardened (i.e. fully set or cured) hardenable bone cement comprising a bioabsorbable bone substitute material suitable for the treatment of bone disorders and filling of bony voids or defects of the skeletal system;
“bone substitute material” means a bioabsorbable material, e.g. calcium sulphate hemihydrate and tricalcium phosphate, which is used for the treatment of bone disorders and filling bony voids or defects of the skeletal system to permit regeneration of natural bone growth in the skeletal system and which is capable of forming a bone cement e.g. when mixed with an aqueous solution;
“hardenable bone cement” means a composition comprising a bone substitute material as defined herein and a hardening agent, e.g. an aqueous solution, which upon hardening (i.e. fully setting) forms a bone cement as defined herein. Typically, the hardenable bone cement is in the form of a workable paste;
“comprising” or any cognate word specifies the presence of stated features, steps, or integers or components, but does not preclude the presence or addition of one or more other features, steps, integers, components or groups thereof. The expressions “consists of” or “consists essentially of” or cognates may be embraced within “comprises” or cognates, wherein “consists essentially of” permits inclusion of substances not materially affecting the characteristics of the composition to which it applies;
“frame” or “rigid frame” means a frame that is substantially resistant to deformation when moderate force is applied to it. The frame may be made from metals such as aluminium, stainless steel or titanium, or rigid plastics such as Acrylonitrile Butadiene Styrene (ABS), PolyStyrene (PS), PolyVynyl chloride (PVC), High Density Polyethylene (HDPE) or Polyetheretherketone (PEEK) or any other material that may fit this definition or purpose.

The various features of the invention, which are applicable as appropriate to all aspects, will now be described in more detail with reference to the following drawings, where:

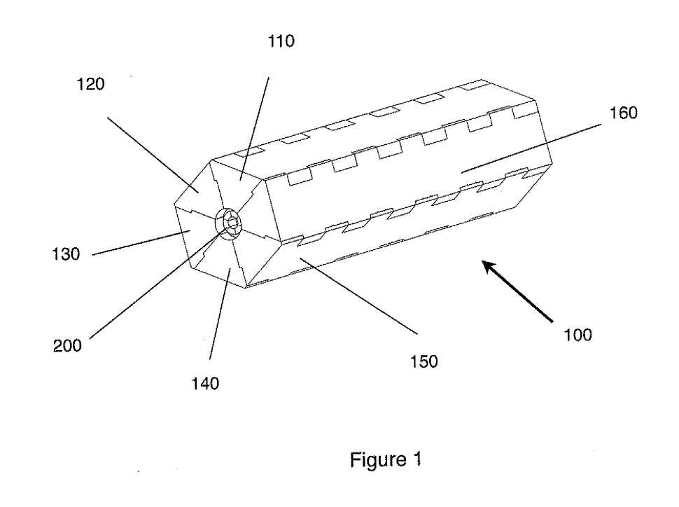

FIG. 1 is a perspective view of a segmented mould in assembled form of a first embodiment of the present invention;

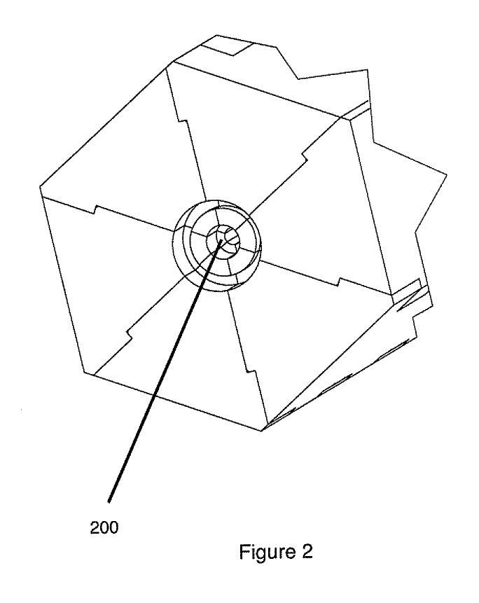

FIG. 2 is a truncated end view of the segmented mould in assembled form of FIG. 1;

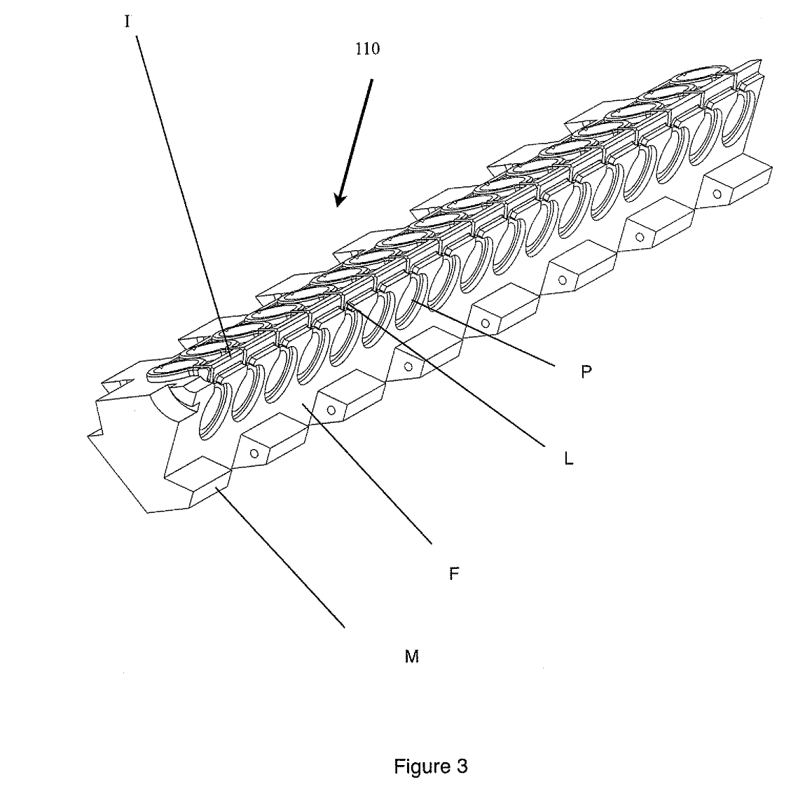

FIG. 3 is a perspective view of a segment (one of six) of the mould of FIGS. 1 and 2;

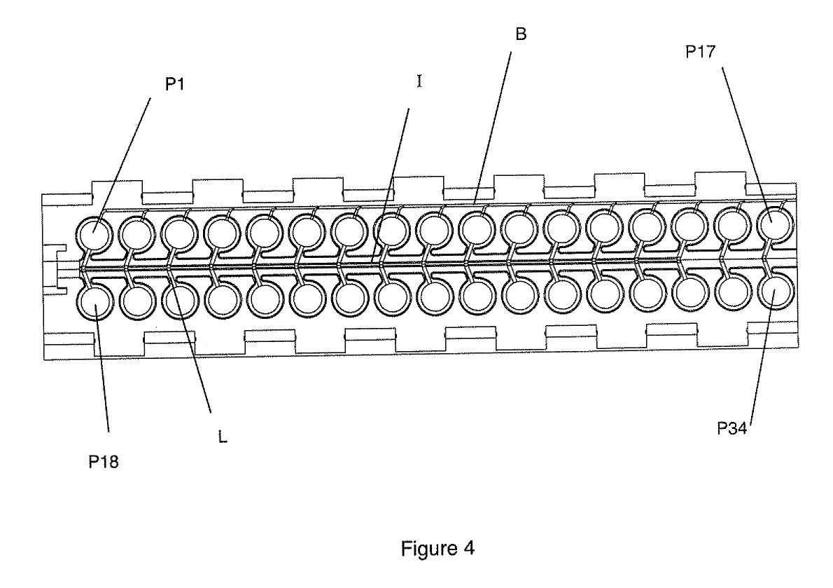

FIG. 4 is a longitudinal cross-sectional view of the assembled mould of FIG. 1;

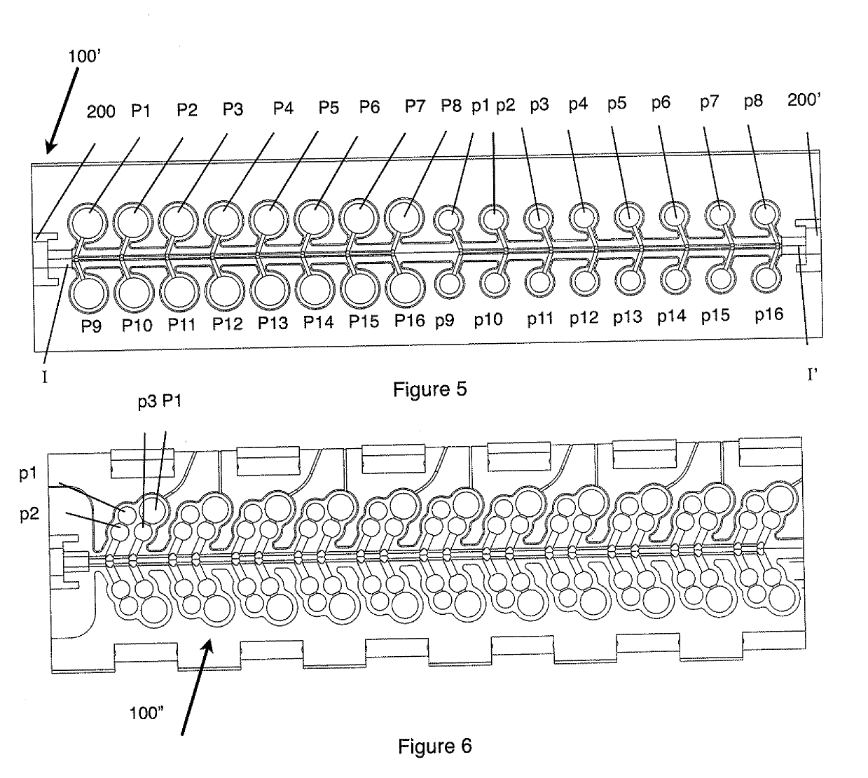

FIG. 5 is a longitudinal cross-sectional view of an assembled mould of a second embodiment of the present invention;

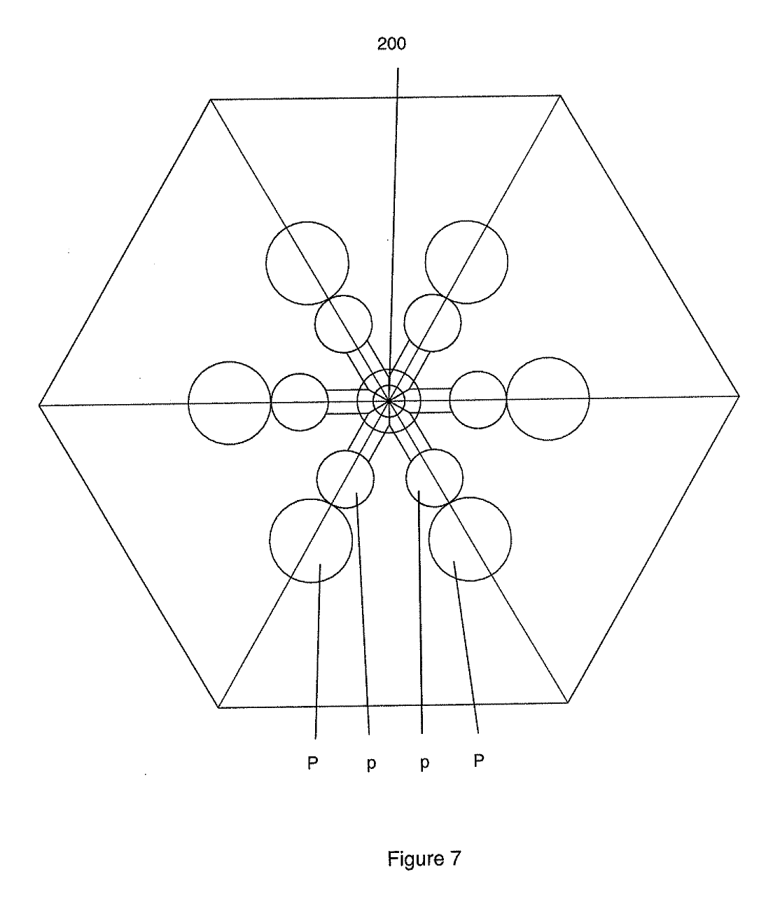

FIG. 6 is a longitudinal cross-sectional view of an assembled mould of a third embodiment of the present invention;

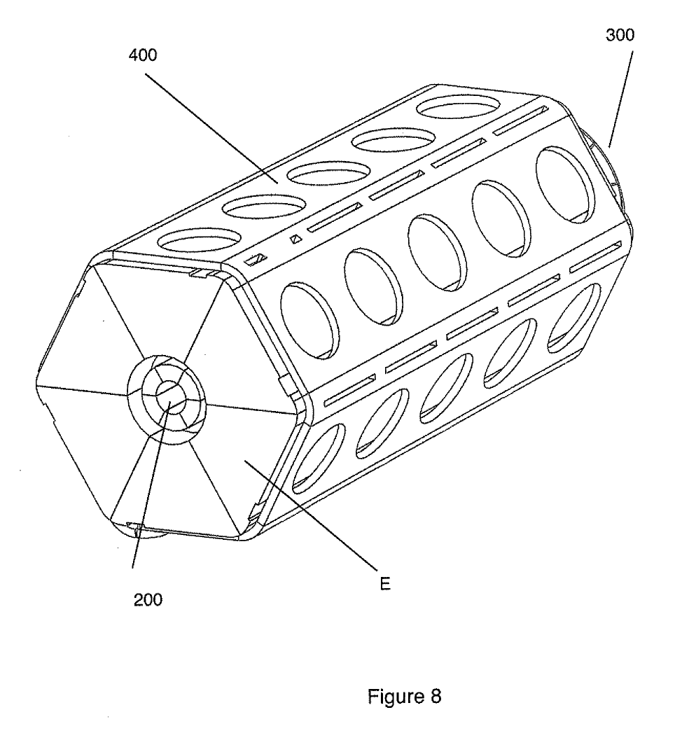

FIG. 7 is a transverse cross-sectional view of a fully assembled segmented mould made up of six mould segments of the type illustrated in FIG. 6;

FIG. 8 is a perspective view of an assembled segmented mould held within a frame;

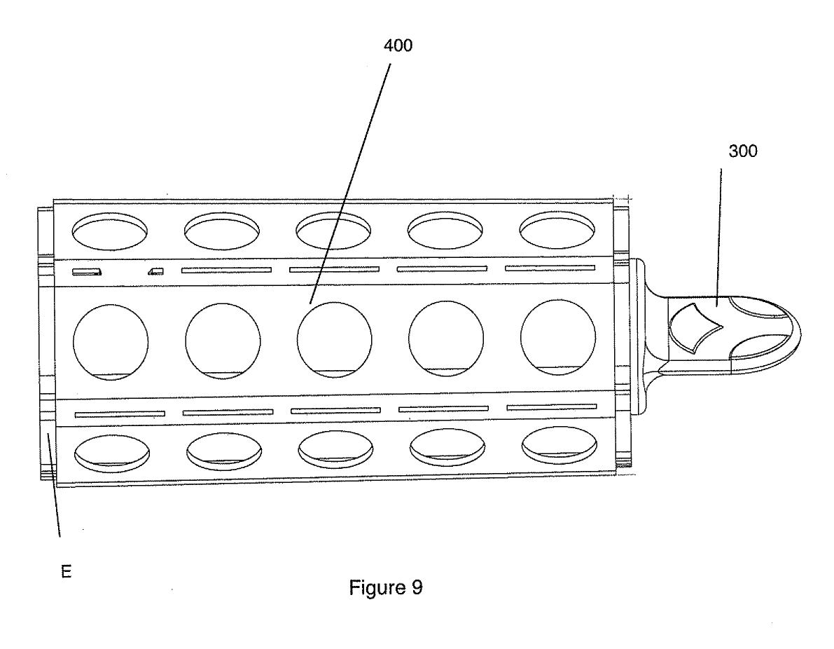

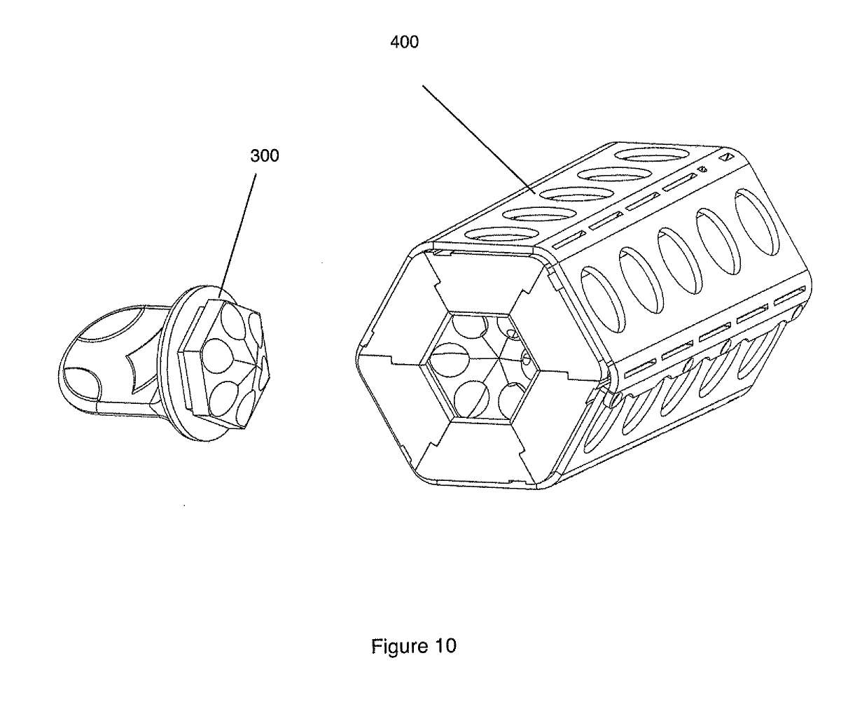

FIG. 9 is a side view of the segmented mould and frame of FIG. 8;

FIG. 10 is a perspective view of the segmented mould, and frame of FIGS. 8 and 9, with the plug removed from the pluggable inspection hole.

### BONE SUBSTITUTE MATERIAL

The bone substituted material comprises a calcium salt based bone substitute material. Typically the bone substitute material is in the form of a solid powder. The bone substitute material when mixed with a hardening agent, for example an aqueous solution (i.e. aqueous salt solution) or water, forms a workable paste (i.e. a hardenable bone cement) which on setting/curing forms a hardened solid bone cement. Suitable calcium salt based bone substitute materials include calcium sulphates, calcium phosphates, calcium carbonates and combinations thereof. Preferably, the bone substitute material comprises at least one calcium sulphate, especially calcium sulphate hemihydrate which when mixed with water sets with a mildly exothermic reaction to produce solid calcium sulphate dihydrate.

The at least one calcium based bone substitute material may be used alone or it may be used in combination with one or more calcium phosphate bone substitute materials or calcium carbonates.

Examples of suitable calcium phosphate bone substitute materials include monocalcium phosphate, dicalcium phosphate, tricalcium phosphate, tetracalcium phosphate, octacalcium phosphate or hydroxyapatite.

In accordance with a preferred embodiment of the present invention, the bone substitute material comprises a mixture of a calcium sulphate and calcium phosphate bone substitute materials, particularly a mixture of calcium sulphate hemihydrate and tricalcium phosphate, especially beta-tricalcium phosphate.

The bone substitute material, and hence the resulting bone cement pellets, may include a therapeutically active agent. Suitable therapeutically active agents include: bone inducing growth factors to accelerate bone growth such as bone morphogenetic proteins and parathyroid hormones; bone breakdown inhibitors such as biphosphonates and osteocalcin; compounds to prevent invasion by foreign living material such as antibiotics, antibacterial compounds, antiviral compounds and antifungal compounds; and anti-inflammatory compounds such as non-steroidal anti-inflammatory compounds (NSAIDs). A highly preferred therapeutically active agent comprises an antibiotic.

Alternatively, or additionally, the bone substitute material, and hence resulting bone cement pellets, may include an agent to enhance visualisation of the bone cement in-vivo. Suitable agents include ionic and non-ionic X-ray contrast agents, preferably non-ionic water soluble X-ray contrast agents, such as iodine based media e.g. iohexyl.

The therapeutically active agent and/or visual enhancement agent may be included in powder form together with the bone substitute material prior to mixing with the aqueous solution. Alternatively, or additionally, the therapeutically active agent and/or visual enhancement agent may be dissolved or dispersed in the aqueous liquid for mixing with the bone substitute material.

The bone cements pellets produced using the mould, as described hereinafter, may be used in surgical procedures to treat bone defects, such as filling bony voids or defects of the skeletal system. The bone cement pellets are packed into the bony void or bony defect where they act as hardened bone substitute material (i.e. a bioabsorbable replacement bone material which acts as a scaffold and promotes the regeneration of natural bone).

### The Mould

FIGS. 1 through 4 show aspects of a first embodiment of a segmented mould in accordance with the teachings of the present invention and will now be described in detail.

FIGS. 1 and 2 show the segmented mould 100 in assembled form. The mould 100 comprises six mould segments 110, 120, 130, 140, 150, 160 made from a flexible polymeric material, such as silicone rubber, which interlock or tessellate to form a finished three-dimensional, segmented mould for the production of bone cement pellets. When fully assembled, the mould has the outer appearance of a hexagonal cylinder or prism and features an exposed injection port 200 at an end region (as seen best from FIG. 2).

Referring to FIG. 3, there is shown one of six identical individual mould segments 110 in perspective view. Each mould segment 110 features a plurality of hemispherical pellet mould cavities P, linked together by an injection channel I which runs the length of the segment. Each of the mould cavities P is connected to the injection channel by its own individual feeder lines L, through which the cavity, in use, receives injected hardenable bone cement. To facilitate each mould segment 110, 120, 130, 140, 150, 160 to co-operate with and interlock to its' two neighbouring segments, alignment features comprising male and female parts M, F are provided. Each male/female part co-operates with and locks into a corresponding female/male part of a neighbouring segment to keep the mould segments aligned and mutually attached. The assembly of a mould from individual segments comprises the clipping together of each identical part with its neighbours. The final assembly of the last segment piece (which effectively acts as a keystone locking all parts together) is facilitated by the flexible nature of the mould material as all parts can be manually flexed to a degree to make the final connection.

Referring to FIG. 4, there is shown a longitudinal cross-sectional view of an assembled mould. The mould features a plurality of hemispherical pellet mould cavities P1-P34, linked together by an injection pathway I (formed by cooperation of each individual injection channel of each mould segment) which runs the length of the mould. Each of the mould cavities P1-P34 is connected to the injection pathway by its own individual feeder lines L, through which the cavity, in use, receives injected hardenable bone cement. Each cavity P1-P34 also features an air bleed outlet to at least one air bleed channel B.

Referring to FIGS. 1 and 2, it can be seen that the final assembled form of the mould 100 presents an end view with a single injection port 200 to which a syringe of hardenable bone cement may be pressed or attached to inject cement. The injection port, as shown, comprises a simple push-on connector formed by the mutual co-operation of each of the assembled mould segments 110, 120, 130, 140, 150, 160. Such an arrangement simplifies the manufacturing process of the mould segments. Alternatively, and not shown, the injection port may include a luer-lock type connector to permit a syringe to be engaged thereto via a screw fit connection. In use, hardenable bone cement is injected and enters the port 200, the cement flows along the channel I and into individual mould cavities P via the feeder lines L. Air from the chambers bleeds out via the bleed channel B of each segment.

During injection of the hardenable bone cement into the assembled mould, the pressure of the cement may force apart the assembled segments. This may be avoided by the use of a rigid ‘frame’ (described later) into which the assembled mould is firmly located.

The method and apparatus described above has been described in relation to producing bone cement pellets of a single size, however it will be realised that different sized pellets may be produced by using different mould segments with varied sizes of mould cavities.

FIG. 5 shows a longitudinal cross-sectional view of an assembled mould 100′ of a second embodiment of the present invention with first (“P”) and second (“p”) sizes of mould cavities. The mould includes a first 200 and second 200′ injection port. In the mould shown the larger mould cavities P1-P16 are closer to the first injection port end 200 and connected thereto by injection pathway I (formed by cooperation of each individual first injection channel of each mould segment) and feeder lines L (not shown), whereas the smaller cavities p1-p16 are closer to the second injection port end 200′ and connected thereto by a separate injection pathway I′ (formed by cooperation of each individual second injection channel of each mould segment) and feeder lines L′. Such an arrangement allows the user to form independently differing sizes of bone cement pellets by either injecting hardenable bone cement into the first injection port 200 or the second injection port 200′. The mould 100′ features the same one or more bleed channels B (which although not visible in FIG. 5 is still provided).

FIG. 6 shows a longitudinal cross-sectional view of an assembled mould 100″ of a third embodiment of the present invention which has multiple sizes of mould cavities to maximise the use of space available. The construction of the mould shown in FIG. 6, appears more complicated than the previously described embodiments but in fact it is no different from a functional point of view having the same common features. However, instead of individual cavities P, p, being directly connected to the central injection pathway I (formed by cooperation of each individual injection channel of each mould segment), subsidiary cavities are provided which receive hardenable bone cement from neighbouring cavities. In other words, a combination of same (e.g. p2,p1 in FIG. 6) or differently sized cavities (e.g. p3, P1) are provided in line so that hardenable bone cement passes into a first cavity from the injection pathway and then passes through to a second cavity (and possibly more) until the serially connected mould cavities have been filled with cement. In use, it has been found that providing extra chambers connected in this way within the assembled mould gives a particularly good result in terms of pellet shape and uniformity of consistency.

FIG. 7 shows a transverse cross-sectional cut through of a fully assembled mould consisting of the type shown in FIG. 6. This illustrates the interconnection possibilities between differently or same sized mould cavities.

Whilst a few particular layouts have been discussed, it will be appreciated that many different constructions could also be applied where multiple cavities are individually fed via different layouts and arrangements of feeder lines L and bleed channels.

In use of the device it is a particular concern to ensure that the hardenable bone cement should be fully set or cured prior to opening of the mould. In order to assess the cured status of the cement such that premature opening of the mould need not occur, a removable plug 300 may be incorporated into the mould. This can reveal the state of one or more pellets without needing to open the mould. Once the state of such pellets has been observed, the user can judge whether it is the right time to open the mould.

A mould arrangement is shown in FIGS. 8, 9 and 10, whereby a frame 400 and plug 300 are employed. The frame 400 serves to maintain rigidity during the injection and hardening process, while the plug 300 is provided to allow for inspection.

To allow for a good friction fit of the segmented mould 100 within the rigid frame 400 both have a slight taper end to end and this can best be seen by referring to FIG. 9, where the left end (the injector end) has a slightly larger outer cross-sectional area than the right, plug, end. By making the end of the mould having the injection port to be of a larger cross section it is ensured that any pressure applied to the syringe towards the mould, through the injection port 200, results in a force which pushes the mould into the frame 400 rather than out of the frame. The frame 400 itself is therefore tapered similarly to conform to the shape of the assembled mould 100. The length of the frame 400 may be slightly less than the length of the mould 100.

It will be appreciated that the design of the individual mould segments 110-160 at the “plug end” is specifically shaped according to the desired plug configuration.

In use, the segmented mould can be supplied fully assembled either with or without frame to a customer. If the mould and frame/plug combination are supplied fully assembled, then all a user needs to do is to mix the bone substitute material, powder plus liquid, to a desired consistency to form a hardenable bone cement, fill an injection syringe and apply the hardenable cement through the injection port 200 directly from the syringe. Following injection, the user then leaves the mould/frame combination for the designated hardening/setting time (typically 15 to 20 minutes) and can optionally use the inspection plug facility to check the state of the pellets before removing the mould from the frame—this time using the taper of the frame and mould combination to extract the mould easily. The mould can then be simply pulled apart, by virtue of the flexible nature of the polymeric material from which it is made, and the pellets removed.

To summarise, the mould, mould segments, frame and plug arrangements described above and the method of forming bone cement pellets using them allow pellets to be formed in a simple clean and efficient manner by a user. The method also results in pellets that are of consistently high quality (i.e. uniform in shape and consistency) produced in relatively large quantities in a single operation.

It is to be understood that various modifications may be made without departing from the scope of the invention, for example:

The mould may consist of more or less segments than that described herein.

The number, size, shape and geometric arrangement of the cavities in each segment may be different from those described herein.

The pellet geometry may be spherical or hemispherical, or alternatively spheroidal, ellipsoidal or cylindrical, or a combination of these geometries.

The mould may have more than one injection port, for example an injection port at each end, each giving the user the choice of pellet size, shape or quality.

The mould may have an injection port at some other position along its length such that the hardenable bone cement may be directed to fill a selected plurality of cavities.

Some other means, besides a frame, for surrounding the mould may be adopted to hold together the mould segments during injection of the hardenable bone cement, such as tension bands or spring clips.

1. A mould for producing bone cement pellets, the mould comprising a plurality of complementarily shaped mould segments which fit together to make a composite mould having a plurality of individual mould cavities and one or more injection ports for feeding, in use, hardenable bone cement to said mould segments and said plurality of individual mould cavities.

2. A mould according to claim 1, wherein each mould segment comprises a mould member with one or more injection channels running along its length and a plurality of individual mould cavities distributed around said one or more injection channels and directly linked to said one or more injection channels by one or more feeder lines.

3. A mould according to claim 2, wherein a mould segment comprises one or more supplementary mould cavities which are linked to said one or more injection channels via one or more of said directly linked mould cavities.

4. A mould according to claim 3, wherein a mould segment comprises further mould cavities serially linked to said supplementary cavities.

5. A mould according to claim 3, wherein said one or more supplementary mould cavities comprises a mould cavity of a different size to its associated, directly linked, cavity.

6. A mould according to claim 2, wherein each mould member includes a single injection channel running along its length.

7. A mould according to claim 6, wherein said plurality of mould segments, when assembled together, define between them a single injection pathway, preferably a single central injection pathway, for the introduction, in use, of hardenable bone cement.

8. A mould according to claim 1, wherein the composite mould includes a single injection port.

9. A mould according to claim 2, wherein each mould member includes a first injection channel and a second separate injection channel running along its length and said plurality of individual mould cavities comprises a plurality of first individual mould cavities and a plurality of second individual mould cavities, wherein the plurality of first individual mould cavities are distributed around said first injection channel and directly linked to it by one or more feeder lines and the plurality of second individual mould cavities are distributed around said second separate injection channel and directly linked to it by one or more feeder lines.

10. A mould according to claim 9, wherein the plurality of first individual mould cavities comprises a mould cavity of a different size than the plurality of said second individual mould cavities.

11. A mould according to claim 9, wherein said plurality of mould segments, when assembled together, define between them a first injection pathway and a second separate injection pathway, preferably a first central injection pathway and a second separate central injection pathway, for the introduction, in use, of hardenable bone cement.

12. A mould according to claim 1, wherein the composite mould includes two injection ports.

13. A mould according to claim 2, wherein each mould segment is arranged to co-operate with a neighbouring mould segment to either side.

14. A mould according to claim 13, wherein each mould cavity comprises a half mould for a finished bone pellet.

15. A mould according to claim 13, wherein each pair of co-operating mould segments bring together adjoining pairs of mould cavities for forming complete bone pellets.

16. A mould according to claim 2, wherein said mould comprises a plurality of interconnected and substantially identical mould segments.

17. A mould according to claim 16, wherein each mould segment comprises alignment features for automatically aiding the alignment of adjoining mould segments.

18. A mould according to claim 17, wherein the alignment features comprise male and female co-operative parts.

19. A mould according to claim 17, wherein said alignment features act to interlock mould segments to each other.

20. A mould according to claim 2, wherein the assembled mould is an elongate mould that is tapered from one end to the other.

21. A mould according to claim 20, wherein, a port for injection of bone cement is provided at the end of said assembled mould having the greater cross sectional area.

22. A mould according to claim 1, wherein the assembled mould is provided with a pluggable inspection hole.

23. A mould according to claim 22, wherein said pluggable inspection hole is situated at the end of the mould opposite to the end having the injection port.

24. A mould according to claim 22, wherein the pluggable hole allows visual access to the interior of the mould so that a state of curing of the contents of the mould may be assessed.

25. A mould according to claim 1, further comprising air bleed channels to permit escape of air from the mould during the injection of hardenable bone cement.

26. A mould according to claim 1, wherein each of said mould segments comprises a flexible material.

27. A frame for surrounding a mould, the mould being in accordance with claim 1.

28. A frame according to claim 27, wherein said frame is an elongate cylinder, preferably elongate prism, having inner dimensions which are arranged to closely conform to the outer dimensions of an assembled mould.

29. A frame according to claim 28, wherein said frame is tapered end to end.

30. A frame according to claim 29, wherein said frame comprises a first end giving access to an injection port of said mould and a second end providing means for locating a plug for plugging said mould.

31. A kit of parts for producing bone pellets, said kit comprising:
(i) an assemblable mould formed from a plurality of complementarily shaped mould segments, which, when assembled together, form a composite mould having a plurality of individual mould cavities and one or more injection ports for feeding, in use, hardenable bone cement to said mould segments and said plurality of individual mould cavities; and,
(ii) a frame for co-operation with the assembled mould during an injection and hardening process of said hardenable bone cement.

32. A kit of parts according to claim 31, wherein said mould comprises a mould for producing bone cement pellets, the mould comprising a plurality of complementarily shaped mould segments which fit together to make a composite mould having a plurality of individual mould cavities and one or more injection ports for feeding, in use, hardenable bone cement to said mould segments and said plurality of individual mould cavities, and said frame comprises a frame for surrounding such mold.

33. A kit of parts according to claim 31, further comprising a syringe for the injection of hardenable bone cement.

34. A kit of parts according to claim 31, further comprising a bone substitute material for forming a bone cement.

35. A method for the production of bone cement pellets, the method comprising:
(i) injecting hardenable bone cement into a mould, the mould comprising a plurality of complementarily shaped and inter-engaged mould segments which form a composite mould having a plurality of individual mould cavities and one or more injection ports for feeding, in use, hardenable bone cement to said mould segments and said plurality of individual mould cavities;
(ii) allowing said bone cement to harden in said mould; and,
(iii) disassembling the mould to access the produced bone cement pellets.

36. The method of claim 35, wherein the mould comprises a mould for producing bone cement pellets, the mould comprising a plurality of complementarily shaped mould segments which fit together to make a composite mould having a plurality of individual mould cavities and one or more injection ports for feeding, in use, hardenable bone cement to said mould segments and said plurality of individual mould cavities.

37. The method of claim 35, further comprising the step of inserting the assembled mould into a relatively rigid framework prior to injecting said hardenable bone cement.

38. The method of claim 37, wherein said framework comprises a frame for surrounding a mould for producing bone cement pellets, the mould comprising a plurality of complementarily shaped mould segments which fit together to make a composite mould having a plurality of individual mould cavities and one or more injection ports for feeding, in use, hardenable bone cement to said mould segments and said plurality of individual mould cavities.
